(19) United States
(12) Patent Application Publication
(10) Pub. No.: US 2001/0037262 A1
(43) Pub. Date: Nov. 1, 2001

(54) System and method of registering sellers in on-line shopping site

(75) Inventor: Takayuki Seto, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/840,143

(22) Filed: Apr. 24, 2001

(30) Foreign Application Priority Data
Apr. 26, 2000 (JP) 2000-125978

(51) Int. Cl. G06F 17/60

(52) U.S. Cl. 705/26

(57) ABSTRACT

A seller registration system is provided that is capable of removing the troublesome or worries in transaction of consumers and of performing a honest business transaction between a consumer and a seller and of collecting innumerable on-line shops on an Internet as broadly as possible. The consumer (1) transmits the connection ID (1ab) to the internet service provider (1b) via the consumer terminal so that the consumer terminal is connected to the internet. When the new on-line shop of the seller (1d) is found, the new on-line shop is introduced to the internet service provider (1b). After the confirmation in credit of both the consumer (1a) and the seller (1d), the internet service provider (1b) implements registration and introduction of the seller (1d) to the on-line shopping site (1ba). Thereafter, the internet service provider (1b) introduces the seller (1d) to the credit card company (1c).

### BACKGROUND OF THE INVENTION

The present invention relates to a system and method of registering sellers managing new on-line shops in an on-line shopping site managed on the Internet by an Internet service provider. The on-line shop means a virtual shop on a network such as the Internet.

Recently, on-line shopping is increasing where a seller manages an on-line shop, or a virtual shop, on a network such as the Internet, whereas a consumer purchases items from the on-line shop.

In the on-line shopping, many consumers have feel drawbacks including (1) troublesome of the procedure for personal identification, (2) anxiety about uploading a credit card number onto a network, and (3) anxiety about certainty to the honest transaction with a seller (or about involvement in fraud).

On the other hand, sellers feel anxiety about honest business transaction with consumers (about reliability of the background and debit conditions of a consumer or about a false order from a consumer). This problem wants means for certainly authenticating specific consumers.

In order to spread more broadly the on-line shopping in future, there are strong needs for the system that can remove the troublesome and anxieties of consumers and can perform a honest transaction between a seller and a consumer. Moreover, the system has been desired that can collect innumerable on-line shops opened on the Internet as far as possible.

### SUMMARY OF THE INVENTION

The present invention is made to solve the above-mentioned problems. An objective of the present invention is to provide a system of registering sellers in an on-line shopping site. The system is capable of removing the troublesome or worries in transaction of consumers and of performing a honest business transaction between a consumer and a seller and of collecting on-line shops on an Internet.

Moreover, another objective of the present invention is to provide a method of registering dealers in an on-line shopping site.

In order to achieve the above-mentioned objects, a seller registration system for registering sellers managing new on-line shops in an on-line shopping site, comprises an internet service provider for managing an on-line shopping site on an internet; and a consumer terminal connected to the internet via the internet on-line provider. The consumer terminal introduces, when finding the on-line shop on the internet, the new on-line shop to the internet service provider. The internet service provider registers a seller managing the new on-line shop introduced by the consumer terminal in the on-line shopping site.

The internet service provider confirms the credibility of a consumer based on the background and debt conditions of the consumer which uses the consumer terminal which has introduced the new on-line shop and confirms the credibility of a seller based on the background and debt conditions of the seller which manages the new on-line shop, thus registering, only when the credibility of the consumer and the seller has been confirmed, the seller in the on-line shopping site.

The internet service provider has personal information about a consumer using the consumer terminal and a credit card number thereof, the internet service provider confirming credibility of the consumer based on the personal background and debt conditions of the consumer based on the personal information and credit card number.

The system further comprises a credit card company connected to the internet service provider via the internet, for paying a charge of internet connection use at the consumer terminal and a charge regarding a business transaction on the internet. The internet service provider pays a charge regarding a business transaction between a consumer using the consumer terminal and the seller via the credit card company based on the credit card number of the consumer.

Moreover, according to the present invention, a seller registration system for registering sellers managing new on-line shops to an on-line shopping site, comprises an internet service provider for managing an on-line shopping site on an internet; and a consumer terminal connected to the internet via the internet on-line provider. The consumer terminal introduces a new on-line shop managed by the consumer terminal, to the internet service provider. The internet service provider registers as a seller a consumer using a consumer terminal which has introduced the new on-line shop, in the on-line shopping site. The internet service provider confirms credibility of the consumer based on the background and debt conditions of the consumer, using the consumer terminal, which has introduced the new on-line shop, and registers as a seller the consumer to this on-line shopping site only when the credibility of the consumer has been confirmed.

The internet service provider has personal information and a credit card number of a consumer which uses the consumer terminal. The internet service provider also confirms credibility of a consumer based on the credibility and debt conditions of the consumer based on the personal information and the credit card number.

The system further comprises a credit card company connected to the internet service provider via the internet, for paying a charge of internet connection use at the consumer terminal and a charge regarding a business transaction on the internet. The internet service provider pays a charge regarding a business transaction on the consumer terminal based on the credit card number of the consumer using the consumer terminal, via the credit card company.

The internet service provider previously provides a connection ID for specifying the consumer terminal to the consumer terminal. The consumer terminal transmits the connection ID to the internet service provider when utilizing the on-line shopping site.

Moreover, the present invention relates to a seller registration method for registering a seller managing a new on-line shop in an on-line shopping site using a system. The system has an internet service provider for managing an on-line shopping site on an internet and a consumer terminal connected to the internet via the internet service provider. The method comprises the steps of connecting the consumer terminal to the internet via the Internet service provider; introducing, when the consumer terminal finds the on-line shop on the internet, the new on-line shop to the internet service provider; and registering a seller managing the new on-line shop introduced by the consumer terminal in the on-line shopping site.

The method further comprises the steps of confirming credibility of a consumer based on the background and debt conditions of a consumer, using the consumer terminal, which has introduced the new on-line shop, in the internet service provider; confirming credibility of a seller based on the background end debt conditions of the seller which manages the new on-line shop; and registering the seller in the on-line shopping site only when credibility of the consumer and the seller has been confirmed.

The method further comprises the steps of introducing a seller managing a new on-line shop registered in the on-line shopping site to a credit card company, in the internet service provider, the credit card company being connected to the internet service provider via the internet; and then paying a charge regarding a business transaction on the internet between the consumer using the consumer terminal and the seller via the credit card company from the internet service provider, based on the credit card number of the consumer terminal.

Moreover, the present invention relates to a seller registration method for registering a seller managing a new on-line shop to an on-line shopping site using a system. The system has an internet service provider for managing an on-line shopping site on an internet and a consumer terminal connected to the internet via the internet on-line provider. The method comprises the steps of connecting the consumer terminal to the internet via the internet service provider; introducing a new on-line shop managed by the consumer terminal itself from the consumer terminal to the internet service provider; and registering as a seller the consumer terminal which has introduced the new on-line shop, in the on-line shopping site.

The method further comprises the steps of confirming credibility of a consumer by the internet service provider, based on the background and debt conditions of the consumer, using the consumer terminal, which has introduced the new on-line shop; and registering as a seller the consumer in the on-line shopping site only when credibility of the consumer has been confirmed.

The method further comprises the steps of introducing as a seller a consumer using the consumer terminal to a credit card company connected to the internet service provider via the internet, by the internet service provider; and then paying a charge regarding a business transaction on the internet at the consumer terminal via the credit card company from the internet service provider, based on the credit card number of a consumer using the consumer terminal.

The method further comprises the steps of previously registering a credit card number of a consumer using the consumer terminal in the internet service provider.

The method further comprises the step of transmitting a connection ID from the consumer terminal to the internet service provider when the consumer terminal is connected to via the internet service provider.

The method further comprises the step of previously providing the connection ID from the internet service provider to the consumer terminal.

In the above-mentioned configuration according to the present invention, when finding a new on-line shop, a consumer terminal introduces the new on-line shop to the internet service provider. The internet service provider registers the seller managing the new on-line shop in the on-line shopping site. Thus, information about the new on-line shop on the internet can be obtained from the consumer.

This feature enables the opportunity of collecting information about innumerable on-line shops on the internet on the side of the internet service provider and makes the on-line shopping site more attractive and expandable. Moreover, leasing the on-line shopping site to the seller managing the new on-line shop promises good profits. The seller managing the new on-line shop can gain profits by increasing the sale chance of items.

Moreover, let us now assume that only when the credibility of a consumer and a seller are confirmed, the seller is registered in the on-line shopping site. In this case, on the side of consumers using the consumer terminal, the internet service provider guarantees the background of a new on-line shop managing seller and the correctness of business dealing. On the side of sellers managing a new on-line shop, the internet service provider guarantees the background of the consumer using a consumer-terminal connected to the internet service provider.

Thus, consumers using a consumer terminal can use worry-free the new on-line shop registered in the on-line shopping site. In response to an order from a consumer terminal connected to the internet service provider, the seller managing a new on-line shop can sell items without worrying.

When the internet service provider has personal information about a consumer using a consumer terminal and a credit card number thereof, a consumer using a consumer terminal purchases items from a new on-line shop via the on-line shopping site. This feature can omit the procedure of inputting personal information or information such as credit card numbers. Moreover, the worry that personal information may be diverted onto the internet can be removed.

### BRIEF DESCRIPTION OF THE DRAWINGS

This and other objects, features and advantages of the present invention still become more apparent upon a reading of the following detailed description and drawings, in

FIG. 1 is a diagram illustrating a system for registering seller in an on-line shopping site, according to an embodiment of the present invention; and

FIG. 2 is a flowchart of explaining a method for registering sellers in an on-line shopping site, which uses the registration system shown in FIG. 1.

### DESCRIPTION OF THE EMBODIMENTS

Embodiments according to the present invention will be described below by referring to the attached drawings.

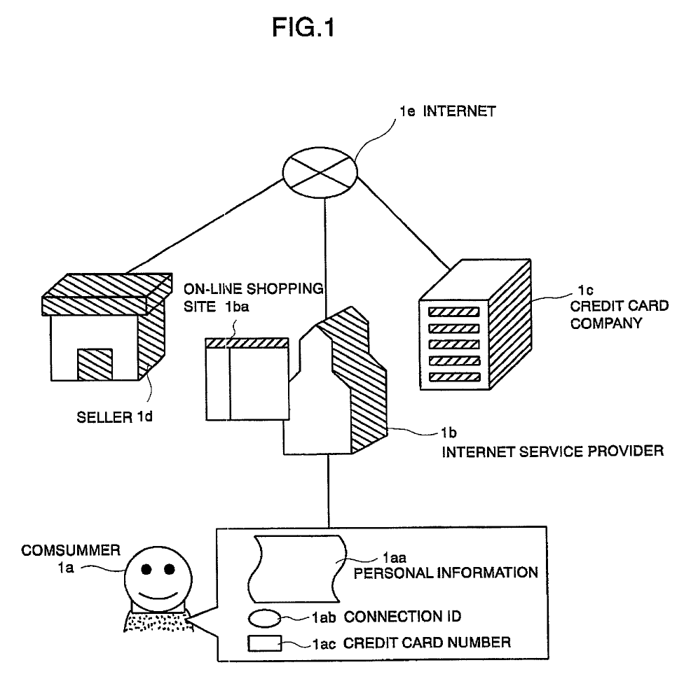

FIG. 1 is a diagram illustrating the system of registering sellers in an on-line shopping site, according to an embodiment of the present invention.

In the configuration shown in FIG. 1, an internet service provider (1b) managing a on-line shopping site (1ba), a credit card company (1c), and an on-line shop managed by a seller (1d) are connected to an internet (1e). When a consumer terminal used by a consumer (1a) uses an internet connection service such as the on-line shopping site (1ba), the consumer terminal is connected to the internet (1e) via the internet service provider (1b).

The on-line shopping site means a home page or web site to be used to sell items via an internet. The on-line shopping site has the function of introducing items to consumers and the counter function of accepting orders from consumers and the function of ordering items to a seller.

In order to provide the internet connection service to the consumer terminal used by the consumer (1a), the internet service provider (1b) previously acquires personal information (1aa) about name, address, telephone number, and so on of the consumer (1a) and information about the credit card number (1ac). Thus, the internet service provider (1b) confirms the reliability of the background and debt conditions of the consumer (1a) based on the sets of information.

For that reason, it is unnecessary, when the consumer (1a) uses the on-line shopping site (1ba), to input and register the personal information (1aa) and the credit card number (1ac) in the on-line shopping site (1ba).

The internet service provider (1b) previously provides as authentication means to specify the consumer (1a) a connection ID (1ab) to the consumer terminal used by the consumer (1a).

When being connected to the internet (1e) via the internet service provider (1b), the consumer terminal used by the consumer (1a) transmits the connection ID provided by the internet service provider (1b), to the internet service provider (1b). Thus, the internet service provider (1b) authenticates the consumer (1a). As a result, the consumer (1a) becomes accessible to the internet (1e).

In order to sell items, the seller (1d) leases as a virtual shop the or-line shopping site (1ba) managed by the internet service provider (1b) and registers the on-line shop to be managed by itself in the on-line shopping site (1ba).

The seller (1d) :may perform a house-to-house selling on the on-line shopping managed by itself, without leasing the on-line shopping site (1ba) as a virtual shop.

When leasing the on-line shopping site (1ba) as a virtual shop to the seller (1d), the internet service provider (1b) conforms the reliability of the background and debit conditions of the seller (1d) and then leases the on-line shopping site (1ba) to the seller (1d).

The credit card company (1c) can generally pay the charge for the use of the internet (1e) at the consumer terminal used by a consumer, based on the credit card number. The internet service provider (1b) pays the use charge of the internet (1e) at the consumer terminal used by a consumer (1a) via the credit card company (1c), based on the credit card number (1ac) of the consumer (1a). The charge for the use of an internet contains an internet connection charge and a charge for the business transaction on an internet.

Next, the method of registering sellers in an on-line shopping site using the registration system with the above-mentioned configuration will be explained below using the flowchart. Here, the on-line shop managed by the seller (1d) is a new on-line shop not registered in the on-line shopping site (1ba) managed by the internet service provider (1ba). Now, the method will be explained of registering the seller (1d) managing the new on-line shop in the on-line shopping site (1ba).

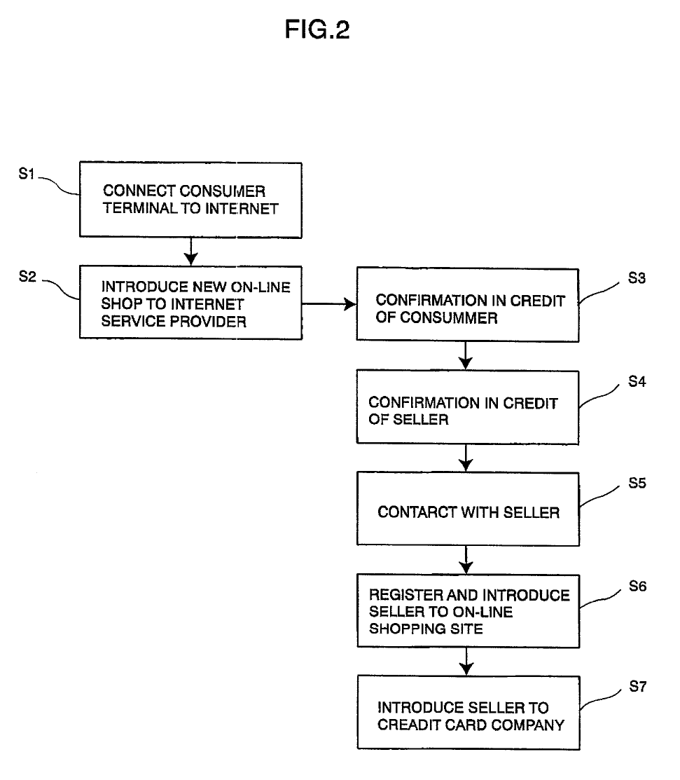

FIG. 2 is a flowchart explaining the method of registering sellers in an on-line shopping site using the registration system shown in FIG. 1. Referring to FIG. 2, the consumer terminal managed by a consumer (1a) carries out the processes in steps S1 and S2. The internet service provider (1b) executes the processes in the steps S3 to S7.

When utilizing the on-line shopping on the internet (1e), the consumer (1a) transmits the connection ID (1ab) to the internet service provider (1b) via the its consumer terminal (1e). When the internet service provider (1b) authenticates the connection ID (1ab), the consumer terminal used by the consumer (1a) is connected to the internet (1e) (step S1).

When a new on-line shop managed by the seller (1d) is hit, during retrieving the site on the internet (1e) via the consumer terminal used by itself, the consumer (1a) introduces it to the internet service provider (1b) (step S2).

When the new on-line shop is introduced via the consumer terminal used for the consumer (1a), the internet service provider (1b) specifies the consumer (1a) based on the connection ID (1ab) transmitted from the consumer terminal at the connection time. Meanwhile, the internet service provider (1b) confirms the background and debit conditions of the consumer (1a) based on the personal information (1aa) and the credit card number (1ac) of the consumer (1a), thus; confirming the credibility of the consumer (1a) (step S3).

Next, the internet service provider (1b) evaluates the adequacy of items to be sold in the new on-line shop managed by the seller (1d) and confirms the credibility of the seller (1d) based on the background and the debit conditions of the consumer (1d) (step S4).

Next, the internet service provider (1b) confirms the will of participation in the on-line shopping site (1ba) of the seller (1d). When the participative will of the seller (1d) is confirmed, the contract on a lease of the on-line shopping site (1ba) is concluded between the internet service provider (1b) and the seller (1d) (step S5).

Next, the internist service provider (1b) performs registration and introduction of the seller (1d) in the on-line shopping site (1ba) managed by itself (step S6).

Thereafter, the internet service provider (1b) introduces the seller (1d) registered in the on-line shopping site (1ba) to the credit card company (1c) (step S7).

The internet service provider (1b) pays charges regarding subsequent business transactions dealt between the consumer (1a) and the seller (1d) on the internet (1e), via the credit card company (1c), based on the credit card number (1ac) of the consumer (1a).

In this embodiment, the example has been explained of finding a new on-line shop at a consumer terminal used by a consumer and introducing the seller managing the new on-line shop to an internet service provider. However, the present invention may be applicable to the case where a consumer itself is a seller and a new on-line shop managed by the consumer is introduced to an internet service provider.

In the present invention described above, when a consumer terminal finds a new on-line shop, the consumer terminal introduces the new on-line shop to an internet service provider. Then, the internet service provider registers the seller managing the new on-line shop introduced by the consumer terminal, in the on-line shopping site. Hence, information about new on-line shops can be obtained from consumers.

This feature allows the opportunity of gathering information about innumerable on-line shops on the internet to be increased on the side of the internet service provider. Thus, it is possible to make the on-line shopping site more attractive and expandable. The internet service provider can raise profitability by leasing the on-line shopping site to the new on-line shopping managing seller. Moreover, the seller managing a new on-line shop can increase profits because of the increased chance for selling items.

Let us now assume that only when the credibility of a consumer and a seller is confirmed, the seller is registered in an on-line shopping site. In such a case, on the side of the consumer using a consumer terminal, the internet service provider guarantees the background of a new on-line shop managing seller and the correctness of the business transaction. Moreover, on the side of seller managing a new on-line shop, the internet service provider guarantees the background of a consumer using a consumer terminal linked to the internet service provider.

This feature allows the consumer using a consumer terminal to use a new on-line shop registered in the on-line shopping site, without worrying. Moreover, the sellers managing new on-line shops can sell items to orders from consumer terminals connected to the internet service provider, without worrying.

Moreover, the internet service provider may have personal information about a consumer using a consumer terminal and the credit card number thereof. In such a case, since a consumer using the consumer terminal purchases items from a new on-line shop via an on-line shopping site, the troublesome procedure to input information about person and the credit card number thereof can be omitted. Moreover, the worry that personal information may uploaded onto the internet can be removed.

An internet service provider introduces a seller registered in an on-line shopping site to a credit card company. Then, the internet service provider pays a charge regarding successive business transactions between a consumer using a consumer terminal and the seller via the credit card company, based on the credit card number of the consumer. In such a case, the payment of the charge regarding the transaction on the internet between the consumer and the seller is guaranteed by the credit card company. Hence, the business transaction between the consumer and the seller can be performed safely. Moreover, the consumer using a consumer terminal can pay the charge regarding the business transaction, without notifying the new on-line shop managing seller of the credit card number.

The entire disclosure of Japanese Patent No.2000-125978 filed on Apr. 26, 2000 including specification, claims, drawing and summary are incorporated herein by reference in its entirety.

What is claimed is:

1. A seller registration system for registering sellers managing new on-line shops in an on-line shopping site, comprising:
an internet service provider for managing an on-line shopping site on an internet; and
a consumer terminal connected to said internet via said internet on-line provider;
said consumer terminal introducing, when finding said on-line shop on said internet, said new on-line shop to said internet service provider;
said internet service provider registering a seller managing said new on-line shop introduced by said consumer terminal in said on-line shopping site.

2. The system defined in claim 1, wherein said internet service provider confirms the credibility of a consumer based on the background and debt conditions of said consumer which uses said consumer terminal which has introduced said next on-line shop and confirms the credibility of a seller based on the background and debt conditions of said seller which manages said new on-line shop, thus registering, only when the credibility of said consumer and said seller has been confirmed, said seller in said on-line shopping site.

3. The system defined in claim 2, wherein said internet service provider has personal information about a consumer using said consumer terminal and a credit card number thereof, said internet service provider confirming credibility of sail consumer based on the personal background and debt conditions of said consumer based on said personal information and credit card number.

4. The system defined in claim 3, further comprising a credit card company connected to said internet service provider via said internet, for paying a charge of internet connection use at said consumer terminal and a charge regarding a business transaction on said internet; said internet service provider paying a charge regarding a business transaction between a consumer using said consumer terminal and said seller via said credit card company based on the credit card number of said consumer.

5. A seller registration system for registering sellers managing new on-line shops to an on-line shopping site, comprising:
an internet service provider for managing an on-line shopping site on an internet; and
a consumer terminal connected to said internet via said internet on-line provider;
said consumer terminal introducing a new on-line shop managed by said consumer terminal, to said internet service provider;
said internet service provider registering as a seller a consumer using a consumer terminal which has introduced said new on-line shop, in said on-line shopping site.

6. The system defined in claim 5, wherein said internet service provider confirms credibility of said consumer based on the background and debt conditions of said consumer, using said consumer terminal, which has introduced said new on-line shop, and registers as a seller said consumer to said on-line shopping site only when the credibility of said consumer has been confirmed.

7. The system defined in claim 6, wherein said internet service provider has personal information and a credit card number of a consumer which uses said consumer terminal, said internet service provider confirming credibility of a consumer based on the credibility and debt conditions of said consumer based on said personal information and said credit card number.

8. The system defined in claim 7, further comprising a credit card company connected to said internet service provider via said internet, for paying a charge of internet connection use at said consumer terminal and a charge regarding a business transaction on said internet; said internet service provider paying a charge regarding a business transaction on said consumer terminal based on the credit card number of said consumer using said consumer terminal, via said credit card company.

9. The system defined in any one of claims 1, wherein said internet service provider previously provides a connection ID for specifying said consumer terminal to said consumer terminal; and said consumer terminal transmits said connection ID to said internet service provider when utilizing said on-line shopping site.

10. A seller registration method for registering a seller managing a new on-line shop in an on-line shopping site using a system, said system having an internet service provider for managing an on-line shopping site on an internet and a consumer terminal connected to said internet via said internet service provider, said method comprising the steps of:
connecting said consumer terminal to said internet via said internet service provider;
introducing, when said consumer terminal finds said on-line shop on said internet, said new on-line shop to said internet service provider; and
registering a seller managing said new on-line shop introduced by said consumer terminal in said on-line shopping site.

11. The method defined in claim 10, further comprising the steps of:
confirming credibility of a consumer based on the background and debt conditions of a consumer, using said consumer terminal, which has introduced said new on-line shop, in said internet service provider;
confirming credibility of a seller based on the background and debt conditions of said seller which manages said new on-line shop; and
registering said seller in said on-line shopping site only when credibility of said consumer and said seller has been confirmed.

12. The method defined in claim 10, further comprising the steps of:
introducing a seller managing a new on-line shop registered in said on-line shopping site, to a credit card company, in said internet service provider, said credit card company being connected to said internet service provider via said internet; and
then paying a charge regarding a business transaction on said internet between said consumer using said consumer terminal and said seller via said credit card company from said internet service provider, based on the credit card number of said consumer terminal.

13. A seller registration method for registering a seller managing a new on-line shop to an on-line shopping site using a system, said system having an internet service provider for managing an on-line shopping site on an internet and a consumer terminal connected to said internet via said internet on-line provider, said method comprising the steps of:
connecting said consumer terminal to said internet via said internet service provider;
introducing a new on-line shop managed by said consumer terminal itself from said consumer terminal to said internet service provider; and
registering as a seller said consumer terminal which has introduced said new on-line shop, in said on-line shopping site.

14. The method defined in claim 13, further comprising the service provider.

17. The method defined in any one of claims 10, further comprising:
transmitting a connection ID from said consumer terminal to said internet service provider when said consumer terminal is connected to via said internet service provider.

18. The method defined in claim 17, further comprising the step of:
previously providing said connection ID from said internet service provider to said consumer terminal.
